(19) United States
(12) Patent Application Publication
(10) Pub. No.: US 2011/0146449 A1
(43) Pub. Date: Jun. 23, 2011

(54) METHODS AND COMPOSITIONS COMPRISING POLYOXOMETALATES

(75) Inventors: Jackie Y. Ying, Singapore (SG); Jie Zhang, Singapore (SG); Boon Ping Ting, Singapore (SG)

(73) Assignee: Agency for Science, Technology and Research

(21) Appl. No.: 13/060,184

(22) PCT Filed: Aug. 21, 2009
(86) PCT No.: PCT/SG09/00294

§ 371 Date: Feb. 22, 2011

Related U.S. Application Data
(60) Provisional application No. 61/136,275, filed on Aug. 22, 2008.

(51) Int. Cl. B22F 9/18; C01B 33/20; B82Y 40/00

(52) U.S. Cl. 75/345; 423/326; 977/899

(57) ABSTRACT

The present invention generally relates to compositions and methods comprising polyoxometalates (POMs). In some cases, a reduced form of a POM may be formed via electrolysis in the presence of essentially no supporting electrolyte. The reduced POMs may be used for various applications, for example, for the formation of metallic nanoparticles. Some embodiments of the present invention provide compositions and methods comprising reduced forms of the polyoxometalate, [alpha-SiW₁₂O₄₀]⁴⁻.

### RELATED APPLICATIONS

This application claims priority under 35 U.S.C. §119(e) to co-pending U.S. Provisional Application Ser. No. 61/136,275, filed Aug. 22, 2008, the contents of which are incorporated herein by reference.

### FIELD OF THE INVENTION

The present invention generally relates to compositions and methods comprising polyoxometalates (POMs). In some cases, a reduced form of a POM may be formed by electrolysis of the POM in the presence of essentially no supporting electrolyte. The reduced POMs may be used in various applications, for example, for the formation of metallic nanoparticles. Some embodiments of the present invention provide compositions and methods comprising reduced forms of the polyoxometalate, [alpha-SiW₁₂O₄₀]⁴⁻.

### BACKGROUND OF THE INVENTION

Polyoxometalates (POMs) are stable and highly negatively-charged clusters that exhibit a wide range of structural, redox, and catalytic properties. POMs generally comprise a polyhedral cage structure or framework bearing at least one negative charge which may be balanced by cations that are external to the cage. The framework of a polyoxometalate usually comprises a plurality of metal atoms, which can be the same or different, bonded to oxygen atoms. A POM may also contain centrally located heteroatom(s) surrounded by the cage framework.

POMs may be used in various applications, for example, for the synthesis of metallic nanoparticles, wherein the POMs may act as a reducing and/or stabilizing agent. For example, POMs can be adsorbed onto the surface of metallic nanoparticles to produce repulsive electrostatic forces, thereby stabilizing the metallic nanoparticles against aggregation. Also, since POMs generally exhibit rich redox properties, POMs may serve as reductants to reduce metallic ions to zero valence metal atoms. A key step in the synthesis of metallic nanoparticles using POMs is the generation of the reduced POMs. This may be achieved by (1) photolysis where the exited-state POMs are reduced by a wide varieties of organic substances, (2) electrolysis, (3) radiolysis (e.g., in the presence of 2-propanol), and (4) chemical synthesis. Although electrolysis has been proven to be an effective method for the synthesis of chemical reagents in different redox states, electrolysis methods have not been used for the synthesis of reduced forms of POMs for direct used in nanoparticle synthesis.

### SUMMARY OF THE INVENTION

The present invention generally relates to compositions and methods comprising polyoxometalates (POMs). In some cases, a reduced form of a POM may be formed by electrolysis of the POM in the presence of essentially no supporting electrolyte. The reduced POMs may be used in various applications, for example, for the formation of metallic nanoparticles. Some embodiments of the present invention provide compositions and methods comprising reduced forms of the polyoxometalate, [alpha-SiW₁₂O₄₀]⁴⁻. The subject matter of the present invention involves, in some cases, interrelated products, alternative solutions to a particular problem, and/or a plurality of different uses of one or more systems and/or articles.

In one aspect, a method for forming a plurality of metallic nanoparticles is provided. The method comprises providing a solution comprising a polyoxometalate, wherein the solution comprises essentially no supporting electrolyte, conducting electrolysis in the solution, thereby forming a reduced form of the polyoxometalate, and exposing the reduced form of the polyoxometalate to a metallic nanoparticle precursor, thereby forming a plurality of metallic nanoparticles.

In another aspect, a composition is provided. The composition comprises [alpha-SiW₁₂O₄₀]^{(4+z)-}, wherein z is between 2 and 8.

In yet another aspect, a method for forming a plurality of metallic nanoparticles is provided. The method comprises exposing a metallic nanoparticle precursor to [alpha-SiW₁₂O₄₀]^{(4+z)-}, wherein z is between 2 and 8, under conditions thereby forming a plurality of metallic nanoparticles.

In still another aspect, a method is provided. The method comprises providing a reduced form of a polyoxometalate and exposing a nickel nanoparticle precursor to the reduced form of a polyoxometalate, thereby forming a plurality of nickel nanoparticles.

Other advantages, features, and uses of the invention will become apparent from the following detailed description of non-limiting embodiments of the invention when considered in conjunction with the accompanying drawings, which are schematic and which are not intended to be drawn to scale. In the figures, each identical or nearly identical component that is illustrated in various figures typically is represented by a single numeral. For purposes of clarity, not every component is labeled in every figure, nor is every component of each embodiment of the invention shown where illustration is not necessary to allow those of ordinary skill in the art to understand the invention. In cases where the present specification and a document incorporated by reference include conflicting disclosure, the present specification shall control.

### BRIEF DESCRIPTION OF THE DRAWINGS

FIG. 1 illustrates a ball-and-stick representation of a Leggin-type POM, [alpha-SiW₁₂O₄₀]⁴⁻.

FIG. 2 shows cyclic voltammograms obtained with different switching potentials of (i) −1.05 V, (ii) −0.86 V, (iii) −0.68 V and (iv) −0.44 V for the reduction of 2.0 mM of [alpha-SiW₁₂O₄₀]⁴⁻, according to a non-limiting embodiment.

FIG. 3 shows transmission electron microscopy (TEM) images of Au, Pt, Pd, and Ag nanoparticles formed, according to some embodiments of the present invention

FIG. 4 shows TEM images of Pt nanoparticles synthesized with different reduced forms [alpha-SiW₁₂O₄₀]⁴⁻, according to some embodiments of the present invention.

FIG. 5 shows a TEM image of nickel nanoparticles, according to a non-limiting embodiment.

FIG. 6 shows TEM images of Au—Ag nanoparticles, according to a non-limiting embodiment.

FIG. 7 shows cyclic voltammetric measurements in an aqueous solution containing 1 M methanol and 0.5 M H₂SO₄ at a (i) 2 mm-diameter rough Pt electrode, (ii) commercial carbon black supported Pt nanoparticle modified electrode, and (iii) Pt nanoparticle catalyst modified electrode.

FIG. 8 shows cyclic voltammetric measurements in aqueous 0.5 M H₂SO₄ solution at (i) a 2 mm-diameter rough Pt electrode, and (ii) a Pt nanoparticle modified 3 mm-diameter glassy carbon electrode.

FIG. 9 shows cyclic voltammetric measurements in aqueous 0.5 M H₂SO₄ solution at (i) a commercial carbon black supported Pt nanoparticle modified 3 mm-diameter glassy carbon electrode, and (ii) a Pt nanoparticle modified 3 mm-diameter glassy carbon electrode.

### DETAILED DESCRIPTION

The present invention generally relates to compositions and methods comprising polyoxometalates (POMs). In some embodiments, the methods and compositions comprise reduced forms of polyoxometalates that have not been previously described. In some cases, a reduced form of a POM may be formed by electrolysis of the POM in the presence of essentially no supporting electrolyte. Reduced POMs may be used in various applications, for example, for the formation of metallic nanoparticles.

Polyoxometalates (POMs) are a class of inorganic metal-oxygen clusters. They generally comprise a polyhedral cage structure or framework bearing at least one negative charge which may be balanced by cations that are external to the cage. The framework of a polyoxometalate generally comprises a plurality of metal atoms, which can be the same or different, bonded to oxygen atoms. The POM may also contain centrally located heteroatom(s) surrounded by the cage framework.

Non-limiting examples of classes of POMs which will be known to those of ordinary skill in the art include Keggin-type POMs (e.g., [XM₁₂O₄₀]ⁿ⁻), Dawson-type POMs (e.g., [X₂M₁₈O₆₂]ⁿ⁻), Lindqvist-type POMs (e.g., [M₆O₁₉]ⁿ⁻), and Anderson-type POMs (e.g., [XM₆O₂₄]ⁿ⁻) where X is a heteroatom, n is the charge of the compound, M is a metal (e.g., Mo, W, V, Nb, Ta, Co, Zn, etc., or combinations thereof), and O is oxygen. Generally, suitable heteroatoms include, but are not limited to, phosphorus, antimony, silicon, boron, sulfur, aluminum, or combinations thereof. It should be understood, that while much of the discussion herein focuses on Keggin-type POMs, this is by no means limiting, and those of ordinary skill in the art will be able to apply the methods and teachings herein to other types of POMs. Non-limiting examples of Keggin-type POMs include [SiW₁₂O₄₀]⁴⁻, [PMO₁₂O₄₀]³⁻, [SMo₁₂O₄₀]²⁻, and [PV₂Mo₁₀O₄₀]⁵⁻.

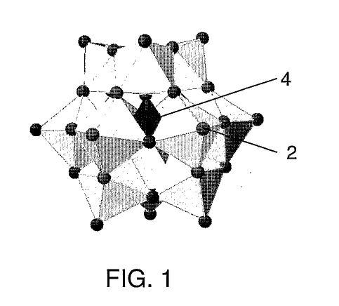

In some embodiments, a POM may be a Keggin-type POM. Keggin-type POMs generally comprise a structure comprising the formula [XM₁₂O₄₀]^{(x-8)-}, wherein X is a heteroatom, x is the oxidation state of the heteroatom, M is Mo or W, and O is oxygen. The at least one negative charge of the complex may be balanced by a counter cation, for example, proton, silver, ammonium, quaternary ammonium, etc., or combinations thereof. A ball-and-stick representation of a Keggin-type POM, [alpha-SiW₁₂O₄₀]⁴⁻, is shown in FIG. 1, wherein balls 2 represent oxygen atoms, center 4 represents Si, and the metal atoms are located within every polyhedral structure formed by the oxygen atoms (not visible in this representation). Other possible structures of Keggin-type POMs are possible, as will be known to those of ordinary skill in the art (e.g., gamma and beta structures).

In some embodiments, the present invention provides compositions comprising a compound having the formula [SiW₁₂O₄₀]^{(4+z)-}, wherein z is between 2 and 8. In some cases, z is between 2 and 6, between 2 and 4, between 1 and 8, between 1 and 6, or the like. In some cases, z is 1, 2, 3, 4, 5, 6, 7, and/or 8. In a particular embodiment, z is 1, 2, or 4 or z is 2, 4, or 8.

In some embodiments, the present invention provides methods for forming a reduced form of a POM via electrolysis. A reduced form of a POM (or reduced POM) refers to a POM which has an oxidation state which is less (e.g., more negative) than the ground oxidation state of the POM. For example, in some cases, a POM having an oxidation state of (n−) may be reduced to formed a reduced form of the POM having an oxidation state of [(n+x)−], wherein x is the change in the oxidation state (e.g., 1, 2, 3, 4, 5, 6, 7, 8, 9, 10, 11, 12, etc.).

In some embodiments, the present invention provides methods for the electrolysis of a POM in the presence of essentially no supporting electrolyte. The presence of essentially no supporting electrolyte is an important feature of the invention, in some embodiments, as it allows for the direct use of the reduced POMs (e.g., [alpha-SiW₁₂O₄₀]⁽⁴⁺ⁿ⁾⁻) in various applications, wherein the applications may not proceed or may be hindered by the presence of supporting electrolyte. For example, a reduced form of a POM may be used as both a reductant and stabilizing agent in the synthesis of metallic nanoparticles, where the formation of the nanoparticles may be hindered by the presence of supporting electrolyte, as described herein.

“Electrolysis,” as used herein, refers to the use of an electric current to drive an otherwise non-spontaneous chemical reaction. For example, in some cases, electrolysis may involve a change in redox state of at least one species (e.g., a POM) and/or formation and/or breaking of at least one chemical bond, by application of an electric current. Those of ordinary skill in the art will be aware of methods and systems for performing electrolysis of a solution. For example, in some embodiments, a voltage (e.g., using an external power source) may be applied between a first and a second electrode which are submerged in the solution comprising the species to be reduced and/or oxidized.

Without wishing to be bound by theory, each metal center comprised in the POM may be able to undergo at least one single-electron transfer reaction. In some cases, POMs may have the ability to accept multiple electrons (e.g., in principle, [alpha-SiW₁₂O₄₀]⁴⁻ can accept up to 12 electrons). In some cases, the reduction or oxidation of a POM may be reversible (e.g., the POM may be able to accept multiple electrons with essentially no decomposition). In some cases, it may be possible to generate multiple electron-reduced forms of a POM by applying a more negative potential during electrolysis. A multiple electron-reduced form is generally a more powerful reductant as compared to its one electron-reduced counterpart.

Those of ordinary skill in the art will be able to determine whether a POM has been reduced by electrolysis, what voltage is required for a POM to undergo reduction by electrolysis, and/or whether the reduction/oxidation is reversible. For example, in some cases, cyclic voltametry may be performed on a solution comprising POMs and a graph of the current vs. potential may be analyzed, thereby determining the voltage required to reduce a POM to a selected oxidation state and/or whether the reduction is reversible. In should be understood, however, that potentials and reversibility may vary depending on the properties of the solution in which electrolysis is being conducted (e.g., presence or absence of supporting electrolyte, pH, etc.), and therefore, the analysis should take place in the solution which is to be employed in further application of the reduced POMs (e.g., for the formation of metallic nanoparticles). As noted above, in some embodiments, the reduction of a POM may be reversible. Without wishing to be bound by theory, the reversibility of a reduction may be an important feature in some embodiments, for example, in embodiments where the reduced POMS are used for the synthesis of metallic nanoparticles.

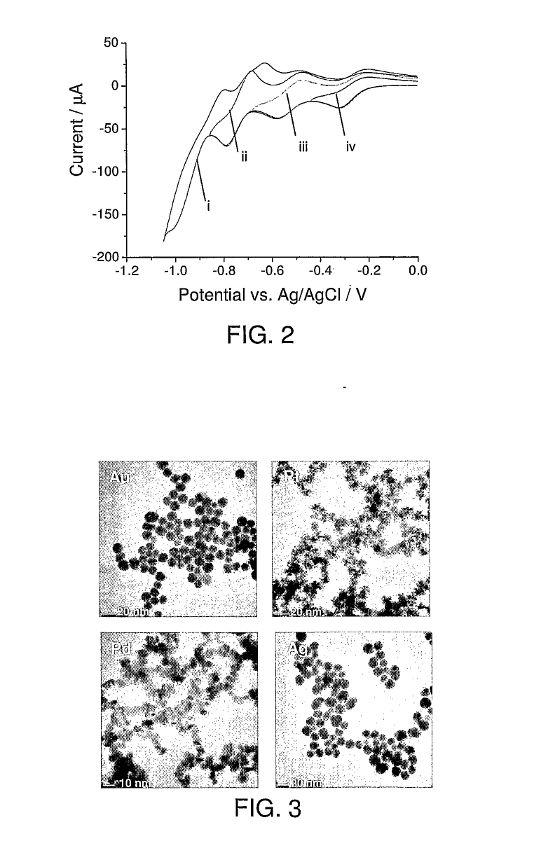

As a specific example of cyclic voltametry, FIG. 2 shows the cyclic voltammograms of [alpha-SiW₁₂O₄₀]⁴⁻ obtained with different switching potentials of (i) −1.05 V, (ii) −0.86 V, (iii) −0.68 V and (iv) −0.44 V at a scan rate of 0.1 V/sec for the reduction of 2.0 mM of [alpha-SiW₁₂O₄₀]⁴⁻ at a 3 mm-diameter glassy carbon electrode. In this figure, a total of four well-defined voltammetric processes within the potential window with mid potentials (average of anodic and cathodic peak potential) of −0.258 V, −0.524 V, −0.736 V, and −0.914 V vs. Ag/AgCl (3 M KCl) reference electrode were observed. The first two processes were one-electron reduction processes (e.g., forming [alpha-SiW₁₂O₄₀]⁵⁻ and [alpha-SiW₁₂O₄₀]⁶⁻). These reduction processes were not highly sensitive to a change in the pH of the solution. The third process was a proton-coupled two-electron process, and its reversible potential was pH-sensitive since highly negative-charged reduced polyanion is a strong base. The fourth process was a four-electron process, with proton coupled to the electron transfer.

In some embodiments, electrolysis may be conducted on a solution comprising a plurality of POMs to be reduced and a suitable solvent (e.g., water, acetonitrile, etc., or combinations thereof). In some cases, the solvent may consist of, or consist essentially of an ionic liquid, for example, 1-butyl-3-methylimidazolium tetrafluoroborate, 1-butyl-3-methylimidazolium hexafluorophosphate, and ethanolammonium nitrate. It should be understood, that while much of the discussion herein relates to solutions that comprise essentially no supporting electrolyte, an ionic liquid is a solvent which comprises no supporting electrolyte where no auxiliary electrolyte has been added to the ionic liquid. For example, the solvent may be an ionic liquid or water, and the ionic liquid or water does not comprise supporting electrolyte in instances where essentially no supporting electrolyte, as described herein, has been added to the solution.

In some embodiments, the solution (e.g., comprising a POM and a solvent such as water or an ionic liquid) may not comprise supporting electrolyte. In some embodiments, the solution may comprise essentially no supporting electrolyte. For example, in some cases, the solution comprises a polyoxometalate and a solvent, wherein essentially no supporting electrolyte has been added to the solvent. The term “supporting electrolyte,” as used herein, is given its meaning which is well understood in the art, and refers to any non-reactive ionic species that is deliberately added to a solvent (e.g., water, acetonitrile, ionic liquid, etc.) or solution for the purpose of increasing the conductivity of the solvent or solution, resulting in a solution containing both the base solvent and the supporting electrolyte. In some cases, “essentially no supporting electrolyte” refers to embodiments wherein the concentration of supporting electrolyte in a solvent is less than about 100 times, less than about 50 times, less than about 30 times, less than about 20 times, less than about 10 times, less than about 8 times, less than about 5 times, less than about 3 times, less than about 2 times, or less than about 1 times, the concentration of POMs in the solvent. While on first reading, these amounts could be considered large, generally, a supporting electrolyte is provided (e.g., for electrolysis) in vast excess (e.g., greater than about 100 times). In a particular embodiment, the concentration of supporting electrolyte in a solvent is less than about 10 times the concentration of POMs in the solvent. In some cases, “no supporting electrolyte” refers to embodiments wherein essentially zero non-reactive ionic species have been added to the solution to increase the conductivity of the solvent.

Non-limiting examples of supporting electrolytes include, but are not limited to, acids, tetrabutylammonium tetrafluoroborate (Bu₄NBF₄), lithium perchlorate (LiClO₄), tetrabutylammonium chloride (Bu₄NCl), tetraethylammonium chloride (Et₄NCl), tetrabutylammonium perchlorate (Bu₄NClO₄), zinc salts, magnesium salts, aluminium salts, sodium salts, potassium salts, and lithium salts. Non-limiting types of salts include metal halides (e.g., chloride, iodide, fluoride, etc.), sulfates, sulfites, nitrates, nitrites, perchlorates, chlorates, etc. Non-limiting types of acids include HCl, HNO₃, H₂SO₄, and HClO₄.

The concentration of POMs in solution may be between about 0.1 mM and about 1 M, between about 0.1 mM and about 100 mM, between about 0.1 mM and about 50 mM, between about 1 mM and about 10 mM, or between about 1 mM and about 50 mM. In some cases, the concentration of POMs in solution may be about 1 mM, about 2 mM, about 3 mM, about 5 mM, about 10 mM, about 25 mM, about 50 mM, about 100 mM, or the like

In some cases, electrolysis is conducted on a solution (e.g., comprising a solvent and a plurality of POMs) for minimums of about 30 seconds, about 1 minute, about 5 minutes, about 10 minutes, about 20 minutes, about 30 minutes, about 60 minutes, and the like. The voltages provided herein, in some cases, are supplied with reference to a silver/silver chloride reference electrode. Those of ordinary skill in the art will be able to determine the corresponding voltages with respect to an alternative reference electrode by knowing the voltage difference between the specified reference electrode and silver/silver chloride or by referring to an appropriate textbook or reference.

The voltage applied to a solution may be held steady, may be linearly increased or decreased, and/or may be linearly increased and decreased (e.g., cyclic). In such instances, the maximum voltage applied to the solution may be at least about −0.1 V, at least about −0.2 V, at least about −0.4 V, at least about −0.5 V, at least about −0.7 V, at least about −0.8 V, at least about −0.9 V, at least about −1.0 V, at least about −1.2 V, at least about −1.4 V, at least about −1.6 V, or greater, vs. a silver/silver chloride electrode.

In some embodiments, the present invention provides methods for forming a plurality of metallic nanoparticles using POMs, wherein the POMs may act as a reducing and/or stabilizing agent. In some cases, the POMs may be formed via electrolysis, as described herein. Although electrolysis has been proven to be a very effective method for the synthesis of chemical reagents in different redox states, electrolysis methods have not been used for the formation of reduced forms of POMs which are then used directly for the formation of a plurality of metallic nanoparticle. Without wishing to be bound by theory, this may be because the supporting electrolyte traditionally used in electrolysis would be thought, by those of ordinary skill in the art, to destabilize and/or prevent formation of the metallic nanoparticles, which are generally electrostatically stabilized. For example, in instances where the stabilization of the metallic nanoparticles by polyanions is based on electrostatic repulsion, the presence of supporting electrolyte could weaken the stabilization (e.g., according to the Gouy-Chapman theory). Thus, for electrolysis to be utilized in the synthesis of metallic nanoparticles, it would be thought that the supporting electrolyte present during the formation of the reduced POMs would likely need to be removed prior to formation of the metallic nanoparticles (which may destabilize the nanoparticles), or the electrolysis would need to be conducted in the presence of no electrolyte. However, those of ordinary skill in the art would not intend to reduce POMs in the absence of supporting electrolyte. As described herein, POMs may be reduced in the presence of essentially no supporting electrolyte, and may then be directly utilized in the formation of metallic nanoparticles. Advantageously, in some cases, the formation of a plurality of metallic nanoparticles using reduced POMs may be conducted in a one-pot reaction, as described herein. It should be understood, however, that the reduced POMs described herein may also be used in applications other than the formation of metallic nanoparticles, for example, (i) as catalysts, (ii) in medicinal applications, (iii) as sensors, or (iv) in other forms of analysis.

Without wishing to be bound by theory, a metallic nanoparticle may be formed as follows. First, at least one reduced POM may be formed, for example, using the methods described here (e.g., via electrolysis), as given in Equation 1, wherein n is the oxidation state of each of the at least one POM and x is the change in oxidation state between the POM and the reduced POM (as described herein). The at least one reduced POM may be exposed to a metallic nanoparticle precursor (e.g., M^{+r} in Equation 2, where r is the oxidation state of the metal ion), wherein the at least one POM is capable of reducing the metallic nanoparticle precursor to a metal atom (e.g., M in Equation 2). The at least one POM may returned to a ground state oxidation state. It should be understood, however, that the at least one POM may return to an oxidation state which differs from the oxidation state of the starting material (e.g., in Equation 1), however, for simplicity, in Equation 2, the at least one POM is shown to return to the original oxidation state. A plurality of metal atoms formed by reduction of the metallic nanoparticle precursor ((t) number) may then associated and form a metallic nanoparticle. (t) may be any number between 10 and 1000, between 50 and 500, between 30 and 300, or the like. In some instances, however, a metallic nanoparticle may be unstable (as indicated in Equation 3), due to the presence various mechanism, such as aggregation and/or other forces. Therefore, in some embodiments, as indicated in Equation 4, the metallic nanoparticle may be stabilized by the association of one or more POMs.

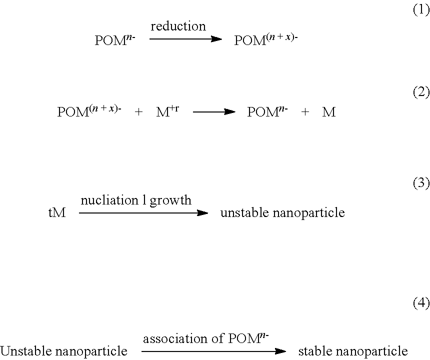

In some cases, a POM may aid in stabilizing a plurality of metallic nanoparticles by producing repulsive electrostatic forces between the metallic nanoparticles, thereby stabilizing the metallic nanoparticles against aggregation. In some cases, a POM may be associated with a metallic nanoparticle via formation of a bond, such as an ionic bond, a covalent bond (e.g., carbon-carbon, carbon-oxygen, oxygen-silicon, sulfur-sulfur, phosphorus-nitrogen, carbon-nitrogen, metal-oxygen, or other covalent bonds), a hydrogen bond (e.g., between hydroxyl, amine, carboxyl, thiol, and/or similar functional groups), a dative bond (e.g., complexation or chelation between metal ions and monodentate or multidentate ligands), Van der Waals interactions, and the like. “Association” of a POM with a metallic nanoparticle would be understood by those of ordinary skill in the art based on this description. In some cases, at least some of the POMs may not be associated with a metallic nanoparticle, for example, some of the POMs may remain in solution (e.g., as a counter ion).

Those of ordinary skill in the art will be able to determine the minimum oxidation state of a POM which is required for the reduction of a metal nanoparticle precursor to a metal atom. For example, in the case of Ni⁺², the reduction, under acidic condition, requires a bias of −0.467 V vs. Ag/AgCl (3 M KCl). Thus, the POM which is to be employed may have a reduction power of at least −0.467 V vs. Ag/AgCl, although in some cases, a POM with a higher reduction power may be required due to reaction conditions (e.g., pH of the solution, presence or absence of supporting electrolyte, etc.).

In some cases, a method for forming a plurality of metallic nanoparticles comprises exposing a metallic nanoparticle precursor to a compound having the structure [alpha-SiW₁₂O₄₀]^{(4+z)-}, wherein z is 1 to 8, or z is between 2 and 8, or any other range or number as described herein. In some cases, the compound may be formed via electrolysis of [alpha-SiW₁₂O₄₀]⁴⁻, as described herein.

In a particular embodiment, the present invention provides a method for forming nickel nanoparticles, the method comprises providing a reduced form of a polyoxometalate, and exposing a nickel nanoparticle precursor to the reduced form of a polyoxometalate, thereby forming a plurality of nickel nanoparticles. The POM may be any polyoxometalate as described herein.

The term “nanoparticle” refers to a particle having a size measured on the nanometer scale, as described herein. In some cases, a nanoparticle may be a metallic nanoparticle, wherein the metallic nanoparticle comprises a plurality of associated metal atoms. In some cases, a metallic nanoparticle may consist or consist essentially of metal atoms. Non-limiting examples of metals a metallic nanoparticle may comprise include Ni, Ag, Au, Pt, and Pd. In some cases, a metallic nanoparticle may comprise more than one type of metal atom. For example, in some instances, a first type and a second type of metallic nanoparticle precursor may be provided to the solution. Therefore, at least a portion of the metallic nanoparticles that form may comprise at least one metal atom from the first metallic nanoparticle precursor and at least one metal atom from the second metallic nanoparticle precursor.

“Metallic nanoparticle precursor,” as used herein, means a composition or compositions which, when subjected to appropriate conditions associated with the present invention, can form metallic nanoparticles. Metallic nanoparticle precursors typically are metal-containing salts which can be reduced, resulting in the formation of metal atoms which may associate and form a metallic nanoparticle. Non-limiting examples of metallic nanoparticle precursors include HAuCl₄, Na₂PdCl₄, K₂PtCl₄, AgNO₃, and Ni(CH₃COO)₂. In some cases, the metallic nanoparticle precursor may comprise a metal ion and a counter anion. For example, the metallic nanoparticle precursor may be a metal halide, a metal oxide, a metal nitrate, a metal hydroxide, a metal carbonate, a metal phosphite, a metal phosphate, a metal sulphite, a metal sulphate, a metal triflate, a metal acetate, and the like. In some cases, more than one type of metallic nanoparticle precursor may be provided to the solution, thereby forming a plurality of metallic nanoparticles comprising more than one metal (e.g., metallic alloy nanoparticles).

In some cases, the methods of the present invention may be one-pot reactions, involving the formation of a plurality of reduced POMs and subsequent use of the reduced POMs in the formation of a plurality of metallic nanoparticles (e.g., without isolation and/or purification of the POMs). The term “one-pot” reaction is known in the art and refers to a chemical reaction which can produce a product in one step which may otherwise have required a multiple-step synthesis, and/or a chemical reaction comprising a series of steps that may be performed in a single reaction vessel. One-pot procedures may eliminate the need for isolation (e.g., purification) of POMs and/or intermediates, while reducing the number of synthetic steps and the production of waste materials (e.g., solvents, impurities). Additionally, the time and cost required to synthesize reduce POMs and/or other products (e.g., metallic nanoparticles) may be reduced. In some embodiments, a one-pot synthesis may comprise simultaneous addition of at least some components of the reaction to a single reaction chamber. In one embodiment, the one-pot synthesis may comprise sequential addition of various reagents to a single reaction chamber.

In some cases, the metallic nanoparticles may have an average diameter between about 0.1 nm and about 100 nm, between about 1 and about 50 nm, between about 1 and about 25 nm, between about 1 and about 10 nm, or the like. In some instances, the metallic nanoparticles may have an average diameter of about 1 nm, about 2 nm, about 3 nm, about 4 nm, about 5 nm, about 10 nm, about 15 nm, about 20 nm, about 25 nm, about 50 nm, or the like. The “average diameter” of a population of nanoparticles, as used herein, is the arithmetic average of the diameters of the nanoparticles. Those of ordinary skill in the art will be aware of methods and techniques to determine the average diameter of a population of nanoparticles, for example, using laser light scattering, dynamic light scattering (or photon correlation spectroscopy), transmission electron microscopy (TEM), etc.

In some embodiments, the size of the metallic nanoparticles may be altered and/or tuned by providing a POM in differing reduced oxidation states. For example, a metallic nanoparticle may be larger when formed using a POM in a first oxidation state than a metallic nanoparticle formed using a POM in a second higher-reduced oxidation state (e.g., more negative oxidation state). Without wishing to be bound by theory, in some cases, formation of smaller metallic nanoparticles in the presence of higher negatively-charged POMs may be due to (1) the reduction of ions occurring at a faster rate when a stronger reductant is used, resulting in the production of smaller nanoparticle nuclei due to the faster nucleation rate and/or (2) a stronger reductant contains a higher number of negative charges and therefore, acts as stronger stabilizing reagents which favors the formation of smaller nanoparticles.

In some embodiments, the nanoparticles may be polydisperse, substantially monodisperse, or monodisperse (e.g., having a homogenous distribution of diameters). A plurality of nanoparticles is substantially monodisperse in instances where the nanoparticles have a distribution of diameters such that no more than about 10%, about 5%, about 4%, about 3%, about 2%, about 1%, or less, of the nanoparticles have a diameter greater than or less than about 20%, about 30%, about 50%, about 75%, about 80%, about 90%, about 95%, about 99%, or more, of the average diameter of all of the nanoparticles. In some embodiments, the nanoparticles are substantially spherical. In other embodiments, however, the nanoparticles may comprise a variety of shapes including spheres, triangular prisms, cubes, plates, flowers (e.g., comprising petals), or the like.

In some cases, the pH of the solution (e.g., the electrolysis solution, and/or the solution for the formation of metallic nanoparticles) may be adjusted. In some cases, the pH of the solution may be adjusted, thereby affected the reduction ability of a POM. In some cases, adjusting the pH of the solution to a more basic pH may increase the reduction potential of a POM. In other cases, adjusting the pH of the solution to more acidic conditions may increase the reduction potential of a POM. In some cases, the pH of the solution may be adjusted (e.g., by addition of an acid or a base), such that the pH of the solution is about neutral (e.g., between about 6.0 and about 8.0, between about 6.5 and about 7.5, and/or about 7.0). In other cases, the pH of the solution is about neutral or acidic. In these cases, the pH may be between about 0 and about 8, between about 1 and about 8, between about 2 and about 8, between about 3 and about 8, between about 4 and about 8, between about 5 and about 8, between about 0 and about 7.5, between about 1 and about 7.5, between about 2 and about 7.5, between about 3 and about 7.5, between about 4 and about 7.5, or between about 5 and about 7.5. In yet other cases, the pH may be between about 6 and about 10, between about 6 and about 11, between about 7 and about 14, between about 2 and about 12, and the like.

In some embodiments, the solution (e.g., the electrolysis solution, and/or the solution for the formation of metallic nanoparticles) may be purged with an inert gas (e.g., nitrogen gas, argon gas, etc.). In some cases, the solution may be purged with a gas which may aid in oxidizing reduced POMs (e.g., oxygen gas).

The following reference is herein incorporated by reference: U.S. Provisional Patent Application Ser. No. 61/136,275, filed Aug. 22, 2008, entitled “Synthesis of metallic nanoparticles using electrogenerated reduced forms of polyoxometalate as both reductants and stabilizing agents,” by Ying, et al.

This and other aspects of the present invention will be further appreciated upon consideration of the following Examples, which are intended to illustrate certain particular embodiments of the invention but are not intended to limit its scope, as defined by the claims.

### Example 1

The following examples described the electrochemistry of [alpha-SiW₁₂O₄₀]⁴⁻ in the aqueous phase comprising no supporting electrolyte and the stability of its reduced forms of [alpha-SiW₁₂O₄₀]⁴⁻, according to some embodiments.

Cyclic voltammetric studies were first conducted to investigate the electrochemical properties of [alpha-SiW₁₂O₄₀]⁴⁻ in the absence of supporting electrolyte. FIG. 2 shows cyclic voltammograms obtained with different switching potentials of (i) −1.05 V, (ii) −0.86 V, (iii) −0.68 V and (iv) −0.44 V at a scan rate of 0.1 V/sec for the reduction of 2.01 M of [alpha-SiW₁₂O₄₀]⁴⁻ at a 3 mm-diameter glassy carbon electrode. In this figure, a total of four well-defined voltammetric processes within the potential window with mid potentials (average of anodic and cathodic peak potential) of −0.258 V, −0.524 V, −0.736 V and −0.914 V vs. Ag/AgCl (3 M KCl) reference electrode. The first two processes were one-electron reduction processes, and were relatively pH-insensitive. The third process was a proton-coupled two-electron process under these conditions, and its reversible potential was highly pH-sensitive since highly negative-charged reduced polyanion is a strong base. The fourth process was a four-electron process with proton coupled to the electron transfer. This process had much more complex voltammetric features than the third process since the kinetics of proton transfer played a role in determining the characteristics of the voltammogram in the time scale of the measurements. Its reversible potential was even more pH-sensitive than the third process since the species involved in this process have a larger number of negative charges, and hence were stronger bases. It should be understood that since a supporting electrolyte was absent, the contribution of migration to mass transport and the electric double layer effect is postulated to influence the shape of the voltammogram.

The stability of the reduced forms, and the chemical reversibility between the reduced forms and the starting material, was investigated. Solutions containing the reduced forms of [alpha-SiW₁₂O₄₀]⁴⁻ were purged with O₂ after electrolysis to re-oxidize them to the original form, [alpha-SiW₁₂O₄₀]⁴⁻. As expected in all cases, the blue solutions of the reduced forms turned colorless as seen in the solution of [alpha-SiW₁₂O₄₀]⁴⁻. Quantitative measurements of the peak current after voltammetric measurements on these colorless solutions confirmed that the decomposition of [alpha-SiW₁₂O₄₀]ⁿ⁻ (n≧4) were insignificant for all the processes of interest in the time scale involved (typically <1 h). In some cases, the redox ability of a species may be indicated by its reversible potential. As the reversible potential was more negative, the reduced form became a more powerful reductant. Therefore, the redox ability of the third and fourth reduced forms of [alpha-SiW₁₂O₄₀]⁴⁻ may be varied significantly by changing the pH of the reaction medium, which may be an advantageous when using reduced forms of POM for the nanoparticle synthesis.

### Example 2

The following examples describe the synthesis of metallic nanoparticles using the 1st reduced form of [alpha-SiW₁₂O₄₀]⁴⁻, according to some embodiments.

Bulk electrolysis of [alpha-SiW₁₂O₄₀]⁴⁻ was first performed at a potential of −0.4 V to generate [alpha-SiW₁₂O₄₀]⁵⁻. Subsequently, the reduced form was added into the following metal ion solutions, [AuCl₄]⁻, [PtCl₄]²⁻, [PdCl₄]²⁻, and Ag⁺. The solution was purged with N₂ to remove O₂ and to mix the reactants uniformly. Since the reactions were thermodynamically favorable, the solutions turned pink for Au nanoparticles, brownish black for Pt nanoparticles and Pd nanoparticles, and yellow for Ag nanoparticles, after several seconds. Transmission electron microscopy (TEM) studies confirmed the formation of nanoparticles with diameters of 15 nm, 4.5 nm, 8 nm and 17 nm for Au, Pt, Pd and Ag, respectively (see FIG. 3 for TEM images). The composition of POM-stabilized metallic nanoparticles has been characterized previously, and the adsorption of POM anion rather than its counter cation to the nanoparticle surface was suggested, based on the results of surface charge measurement.

Inductively coupled plasma-mass spectroscopy (ICP-MS) confirmed the presence of [alpha-SiW₁₂O₄₀]⁴⁻. Since the size of [alpha-SiW₁₂O₄₀]⁴⁻ was known to be ˜1 nm² and the nanoparticle size was also known, the maximum number of [alpha-SiW₁₂O₄₀]⁴⁻ on the nanoparticle surface could be estimated. Analysis suggested that not all of the [alpha-SiW₁₂O₄₀]⁴⁻ species were adsorbed on the nanoparticle surface. In fact, in some cases, most of the [alpha-SiW₁₂O₄₀]⁴⁻ species were not in direct contact with the nanoparticle surface, as indicated also by high-resolution TEM images. For example, some of the [alpha-SiW₁₂O₄₀]⁴⁻ species might exist as counter ions in the solution.

### Example 3

The following example describes the effect on the morphologies of metallic nanoparticles when synthesized using different reduced forms of [alpha-SiW₁₂O₄₀]⁴⁻, according to some embodiments.

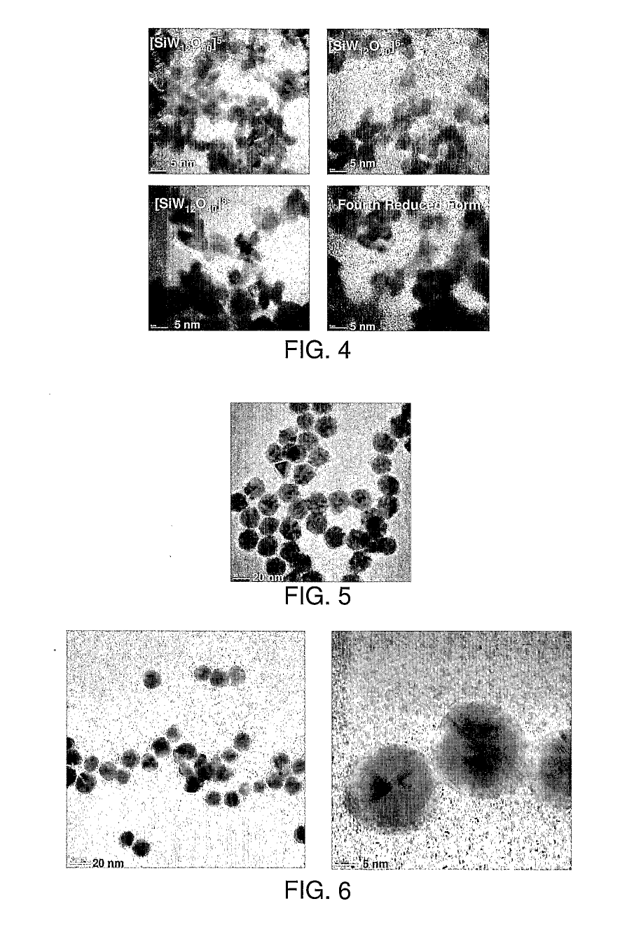

Pt nanoparticles (e.g., as formed in Example 2) had a “flower” morphology. The number of “petals” decreased when [alpha-SiW₁₂O₄₀]⁶⁻, [alpha-SiW₁₂O₄₀]⁸⁻ and the fourth reduction products were used instead of [alpha-SiW₁₂O₄₀]⁵⁻. FIG. 4 shows Pt nanoparticles synthesized with the different reduced forms [alpha-SiW₁₂O₄₀]⁴⁻. The diameter of each petal also decreased from 4.5 nm for the case of [alpha-SiW₁₂O₄₀]⁵⁻ to 3.5 nm for the other cases. This decrease in nanoparticle diameter was also observed in the cases of Au (about 15 nm for [alpha-SiW₁₂O₄₀]⁵⁻ and about 8 nm for the other reduced forms of [alpha-SiW₁₂O₄₀]⁴⁻), and Pd (about 8 nm for [alpha-SiW₁₂O₄₀]⁵⁻ and about 5.5 nm for the other reduced forms of [alpha-SiW₁₂O₄₀]⁴⁻). However, in the case of Ag, the sizes remained almost unchanged when different reduced forms were used. Without wishing to be bound by theory, formation of smaller Au, Pd, and Pt nanoparticles in the presence of stronger and higher negatively-charged POMs may be expect, since (1) when a stronger reductant was used, the reduction of ions may be expected to occur at a faster rate, thereby resulting in the production of smaller nanoparticle nuclei due to the faster nucleation rate. (2) Moreover, the stronger reductants contained higher number of negative charges. Therefore, they were expected to be stronger stabilizing reagents which favor the formation of smaller nanoparticles. Even though higher negatively-charged POMs were stronger reductants, the situation might be more complicated in the case of Ag, since higher negatively changed POMs could complex with positive charged Ag⁺ and might slow down the reduction rate of Ag⁺. The above example shows that size control of the nanoparticles may be achieved using the different reduced forms conveniently derived by reducing the POMs electrochemically.

### Example 4

The following example describes the effect of supporting electrolyte on the formation and the stability of metallic nanoparticles, according to some embodiments.

In electrochemistry, an excessive amount of supporting electrolyte (typically 100 times the analyte concentration) is often used to increase the solution's ionic conductivity, and to simplify theoretical analysis. However, the presence of an electrolyte may affect nanoparticle formation. In some cases, the stabilization of nanoparticles by polyanions is based on electrostatic repulsion, which would be weakened in the presence of supporting electrolyte, according to Gouy-Chapman theory. Experiments were conducted to investigate the effect of acidic supporting electrolyte, e.g., H₂SO₄, on the formation of nanoparticles synthesized using reduced forms of [alpha-SiW₁₂O₄₀]⁴⁻. Acid was chosen in this study since it can be used to increase the solubility of K⁺ or Na⁺ salts of POMs in water. The results suggested that all the nanoparticles mentioned above may, in some embodiments, be synthesized in the presence of millimolar levels of H₂SO₄. In most cases, the presence of millimolar levels of H₂SO₄ did not have a significant effect on the size and morphology of the nanoparticles. However, in the case of Ag, the presence of millimolar levels of H₂SO₄ increased the nanoparticle diameter from about 17 nm to about 45 nm when [alpha-SiW₁₂O₄₀]⁵⁻ was used as the reductant. Higher concentrations of H₂SO₄ may destabilize the Ag nanoparticles, and cause irreversible aggregation. Therefore, bulk electrolysis in the presence of low supporting electrolyte concentration may be used to produce reduced POMs for nanoparticle synthesis without the need for separation and purification of the reduced POMs.

### Example 5

The following example describes the synthesis of nickel nanoparticles, according to some embodiments.

The synthesis of Ni nanoparticles was of special interest because of their magnetic properties. These results suggested that [alpha-SiW₁₂O₄₀]⁵⁻, [alpha-SiW₁₂O₄₀]⁶⁻ and [alpha-SiW₁₂O₄₀]⁸⁻, under these experimental conditions and in this embodiment, were unable to reduce Ni²⁺ to form Ni nanoparticles under various conditions and pHs. The fourth reduced form of [alpha-SiW₁₂O₄₀]⁴⁻ was also not powerful enough to reduce Ni²⁺ under acidic conditions, even though the reduction of Ni²⁺ to bulk Ni was −0.467 vs. Ag/AgCl (3 M KCl) which was more positive than the reversible potentials of the 2nd-4th reduced forms of [alpha-SiW₁₂O₄₀]⁴⁻. Without wishing to be bound by theory, this was most likely due to the fact that the initial reduction of Ni²⁺ to form small cluster of a few atoms was expected to occur at a much more negative potential than the reduction of Ni²⁺ to form bulk Ni, as in the case of Ag⁺ reduction.

However, the addition of NaOH to the solution to adjust the pH to neutral condition generated a more powerful reductant for the Ni²⁺ reduction to form Ni nanoparticles, which could be moved by a magnet. TEM image in FIG. 5 showed that the size of these nanoparticles was about 20 nm. The formation of Ni nanoparticles using POMs as both reductant and stabilizing agent has not been reported before since the photochemically generated [alpha-SiW₁₂O₄₀]⁵⁻ was not a sufficiently strong reductant. This further demonstrated the advantage of using electrochemical method for the generation of the reduced forms of POMs for nanoparticle synthesis.

### Example 6

The following example describes the synthesis of Ag—Au alloy nanoparticles, according to some embodiments.

The application of POMs for the synthesis of binary alloy nanoparticles was also explored. The simultaneous reduction of a mixture of AuCl⁴⁻ and Ag⁺ (molar ratio=5:4) by [alpha-SiW₁₂O₄₀]⁵⁻, [alpha-SiW₁₂O₄₀]⁶⁻, [alpha-SiW₁₂O₄₀]⁸⁻, or the fourth reduced form, produced alloy nanoparticles. TEM images shown in FIG. 6 showed that uniform nanoparticles were formed when [alpha-SiW₁₂O₄₀]⁵⁻ was used. UV-visible spectrum showed a peak shift from 400 nm for pure Ag nanoparticles and 520 nm for pure Au nanoparticles to 500 nm for the Au—Ag alloy nanoparticles. Energy dispersive X-ray (EDX) analysis also confirmed the presence of both Au and Ag. When [alpha-SiW₁₂O₄₀]⁶⁻, [alpha-SiW₁₂O₄₀]⁸⁻, or the fourth reduced form were used, smaller Au—Ag alloy nanoparticles were obtained.

### Example 7

The following describes the application of Pt nanoparticle as electrocatalyst for methanol oxidation, according to some embodiments.

Pt nanoparticle catalysts are an effective anode catalyst for methanol oxidation. Polyoxometalate stabilized Pt nanoparticle catalyst generated from the chemical synthesis method has been proven efficient for alcohol oxidation. The electrocatalytic properties of Pt nanoparticles generated according to Example 3 were applied for methanol oxidation. The Pt nanoparticle-modified electrode was prepared based on a literature procedure described in T. J. Schmidt, H. A. Gasteiger, G. D. Stab, P. M. Urban, D. M. Kolb, R. J. Behm, J. Electrochem. Soc. 1998, 145, 2354-2358.

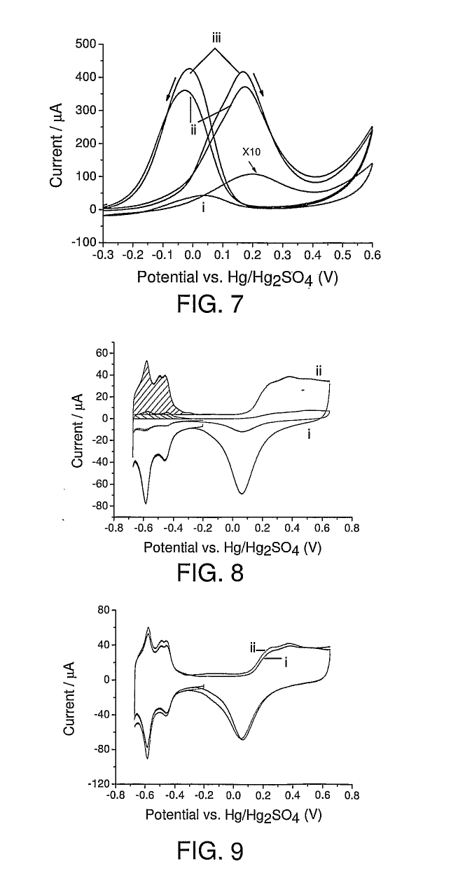

The comparison was first made between Pt nanoparticle catalyst synthesized using the fourth reduced forms of [alpha-SiW₁₂O₄₀]⁴⁻ and bulk Pt disc catalyst. FIG. 7 shows cyclic voltammetric measurement in an aqueous solution containing 1 M methanol and 0.5 M H₂SO₄ at a (i) 2 mm-diameter rough Pt electrode (current was multiplied by 10), (ii) commercial carbon black supported Pt nanoparticle modified electrode, and (iii) Pt nanoparticle catalyst modified electrode. A scan rate of 50 mV s⁻¹ was used. In order to make a fair comparison, the surface areas of both catalysts were measured based on the characteristic hydrogen adsorption process obtained with a cyclic voltammetric measurement in a 0.5 M H₂SO₄ solution. FIG. 8 shows a cyclic voltammetric measurement in aqueous 0.5 M H₂SO₄ solution at (i) 2 mm-diameter rough Pt electrode, and (ii) the Pt nanoparticle modified 3 mm-diameter glassy carbon electrode. The results showed that Pt nanocatalyst had a surface area that was 7 times that of the Pt disc. The diameter of Pt nanoparticles was estimated to be approximately 3.3 mm based on the surface area results, which was consistent with the TEM findings. The catalytic activity of the Pt catalysts towards methanol oxidation was measured by cyclic voltammetric measurements in an aqueous electrolyte solution containing 1 M methanol and 0.5 M H₂SO₄ (see FIG. 7). In the forward potential scan, the adsorbed methanol was oxidized. In the reverse potential scan, the residual carbonaceous species generated from the forward potential sweep were oxidized to CO₂. The peak current could provide the information on the activity of the catalyst. The studies indicated that the Pt nanoparticles had a lower overpotential for methanol oxidation, and were more than 7 times more active than the bulk Pt disc after the difference in their surface area was taken into account.

In comparison with the commercial carbon black supported Pt nanoparticle catalyst, the Pt nanoparticle catalyst prepared according to a non-limiting embodiment of the invention showed approximately 30% higher activity based on the peak current, after the difference in their surface area had been taken into account (FIG. 9). Specifically, FIG. 9 shows cyclic voltammetric measurement in aqueous 0.5 M H₂SO₄ solution at (i) a commercial carbon black supported Pt nanoparticle modified 3 mm-diameter glassy carbon electrode, and (ii) the Pt nanoparticle modified 3 mm-diameter glassy carbon electrode. The voltammetric results of methanol oxidation were also obtained with Pt nanoparticle catalyst synthesized using the other three reduced forms of [alpha-SiW₁₂O₄O]⁴⁻. The information about the anodic potential and the anodic peak current density was summarized in Table 1. The results indicated that both anodic potential and the anodic peak current density were rather comparable in all cases.

TABLE 1
Voltammetric results of methanol oxidation at glassy carbon
electrodes modified with different Pt nanoparticles*

| | | | Anodic peak |
|---|---|---|---|
| | Pt nanoparticle | Peak current | position/V vs. |
| POM Reductant | diameter/nm | density**/mA cm⁻² | Hg/Hg₂SO4 |
| 1^{st} reduced form | 4.5 | 0.95 ± 0.09 | 0.171 ± 0.008 |
| 2^{nd} reduced form | 3.5 | 1.0 ± 0.10 | 0.167 ± 0.006 |
| 3^{rd} reduced form | 3.5 | 0.97 ± 0.10 | 0.172 ± 0.008 |
| 4^{th} reduced form | 3.5 | 1.02 ± 0.12 | 0.170 ± 0.007 |

*Experimental conditions are the same as those described for FIG. 7.
**Surface area of Pt nanoparticles was estimated based on the methods described herein.

### Example 8

The following provides information regarding the materials and methods used for Examples 1-7.

H₄[alpha-SiW₁₂O₄₀], HAuCl₄, Na₂PdCl₄, K₂PtCl₄, H₂PtCl₆, AgNO₃, Ni(CH₃COO)₂, H₂SO₄, methanol, and 5% Nafion 117 solution were purchased from Sigma Aldrich. Carbon black supported Pt nanoparticle catalyst was purchased from Johnson Matthey. 2-5 mM H₄[alpha-SiW₁₂O₄₀] underwent bulk electrolysis using a three electrochemical cell with glassy carbon beaker as the working electrode, Ag/AgCl (3 M KCl) as a reference electrode, and Pt gauze as a counter electrode. CHI 760C potentiostat (CH Instruments, Inc., Texas, USA) was used for controlled potential electrolysis. The H₄[alpha-SiW₁₂O₄₀] solution was purged with N₂ gas to remove O₂, and to increase the mass transport rate during the electrolysis (˜20-40 min). The reduced forms of [alpha-SiW₁₂O₄₀]⁴⁻ were added to millimolar and submillimolar levels of metal ions or their mixtures to produce the respective nanoparticles. All experiments were conducted at 25° C. TEM experiments were performed on a JEOL JEM-3010 electron microscope (200 kV).

For the preparation of Pt modified electrode, a known amount of Pt nanoparticles were dissolved in 0.2 ml of diluted Nafion solution (5% Nafion in low aliphatic alcohols diluted 10 times in deionized water) and 1 ml of deionized water. Finally, 5 μl of the solution were transferred to a 2 mm-diameter glassy carbon electrode using a micropipette. This electrode was left to dry in air, which resulted in a glassy carbon electrode modified with a thin film of Pt nanoparticle catalyst. The typical loading of Pt was 14 ug (milligram) cm⁻².

For measurements of Pt surface area, integration of shaded areas in FIG. 8 provides information on the Pt surface area of Pt disc and the Pt nanoparticle modified electrode. In this calculation, it was assumed that one atom of hydrogen per surface platinum atom at the reversible hydrogen potential. Therefore, a total charge of 210 uC (microcoulomb) per cm² of Pt surface area could be estimated. The Pt surface area of commercial carbon black supported Pt nanoparticle modified electrode was obtained similarly (FIG. 9).

To synthesize Pt, Pd, Au and Ag nanoparticles, the reduced forms of H₄[alpha-SiW₁₂O₄₀] were firstly generated through controlled potential bulk electrolysis in an aqueous solution containing 2-5 mM of H₄[alpha-SiW₁₂O₄₀]. The H₄[alpha-SiW₁₂O₄₀] solution was purged with N₂ gas to remove O₂ gas and to increase the mass transport rate during the electrolysis (˜20-40 min). The reduced forms of H₄[alpha-SiW₁₂O₄₀] generated were then introduced to an O₂ free aqueous solution containing PtCl₆²⁻, PdCl₄²⁻, AuCl₄⁻, or Ag⁺. In some embodiments, N₂ purging was conducted to minimize any effect of O₂ gas and to ensure that the two solutions were mixed uniformly. The final concentrations of both reduced forms of H₄[alpha-SiW₁₂O₄₀] and metal ion were about 1 mM.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed:

1. A method for forming a plurality of metallic nanoparticles, comprising:
providing a solution comprising a polyoxometalate, wherein the solution comprises essentially no supporting electrolyte;
conducting electrolysis in the solution, thereby forming a reduced form of the polyoxometalate; and
exposing the reduced form of the polyoxometalate to a metallic nanoparticle precursor, thereby forming a plurality of metallic nanoparticles.

2. A composition, comprising:
[alpha-SiW₁₂O₄₀]^{(4+z)-}, wherein z is between 2 and 8.

3. A method for forming a plurality of metallic nanoparticles, comprising:
exposing a metallic nanoparticle precursor to [alpha-SiW₁₂O₄₀]^{(4+z)-}, wherein z is between 2 and 8, under conditions thereby forming a plurality of metallic nanoparticles.

4. A method, comprising:
providing a reduced form of a polyoxometalate; and
exposing a nickel nanoparticle precursor to the reduced form of a polyoxometalate, thereby forming a plurality of nickel nanoparticles.

5. The method of claim 1 or 4, wherein the polyoxometalate comprising a compound having the formula [alpha-SiW₁₂O₄₀]⁴⁻.

6. The method of claim 1 or 4, wherein the reduced form of a polyoxometalate comprises a compound having the formula [alpha-SiW₁₂O₄₀]^{(4+z)-}, wherein z is between 1 and 8.

7. The method or composition of any preceding claim, wherein z is between 2 and 8.

8. The method or composition of any preceding claim, wherein z is 2, 4, or 8.

9. The method of claim 1, wherein the providing, conducting, and exposing steps are conducted in a one-pot reaction.

10. The method of any preceding claim, wherein the metallic nanoparticles comprise a metal selected from the group consisting of Au, Ag, Pd, Pt, and Ni.

11. The method of any preceding claim, wherein the metallic nanoparticle precursor comprises a first type of metallic nanoparticle precursor and a second type of metallic nanoparticle precursor.

12. The method of claim 11, wherein the metallic nanoparticles comprise at least one metal atom from the first type of metallic nanoparticle precursor and at least one metal atom from the type of second metallic nanoparticle precursor.

13. The method of any preceding claim, wherein the metallic nanoparticle precursor is exposed to a polyoxometalate in solution.

14. The method of any preceding claim, wherein the exposing step comprising exposing a solution comprising [alpha-SiW₁₂O₄₀]^{(4+z)-} to the metallic nanoparticle precursor.

15. The method of any preceding claim, wherein the exposing step comprising exposing a solution comprising the reduced polyoxometalate to the nickel nanoparticle precursor.

16. The method of any preceding claim, wherein the solution is purged with an inert gas.

17. The method of any preceding claim, wherein the solution comprises essentially no supporting electrolyte.

18. The method of any preceding claim, wherein the concentration of supporting electrolyte in the solution is less than about 30 times the concentration of the polyoxometalates in the solution.

19. The method of any preceding claim, wherein the concentration of supporting electrolyte in the solution is less than about 10 times the concentration of the polyoxometalates in the solution.

20. The method of any preceding claim, wherein the pH of the solution is adjusted to be about neutral.
